(19) United States
(12) Patent Application Publication
(10) Pub. No.: US 2015/0282265 A1
(43) Pub. Date: Oct. 1, 2015

(54) Display Structure

(71) Applicants: Macroblock, Inc., Hsinchu (TW); Harvatek Corporation, Hsinchu (TW)

(72) Inventor: Meng-Hsiu Wei, Hsinchu (TW)

(21) Appl. No.: 14/670,736

(22) Filed: Mar. 27, 2015

(30) Foreign Application Priority Data
Mar. 28, 2014 (TW) 103111791

(51) Int. Cl. H05B 33/08; H05B 33/12

(52) U.S. Cl. CPC H05B 33/0842; H05B 33/12

(57) ABSTRACT

A display structure includes a main body, a plurality of light-emitting diode units, and a plurality of light blocking walls. The main body includes a substrate, and a circuit unit disposed on the substrate. The light-emitting diode units are electrically connected to the circuit unit and illuminate outwardly. Each of the light blocking walls is disposed between two adjacent ones of the light-emitting diode units to prevent light interference between the two adjacent ones of the light-emitting diode units.

### CROSS-REFERENCE TO RELATED APPLICATION

This application claims priority of Taiwanese Patent Application No. 103111791, filed on Mar. 28, 2014.

### FIELD

The disclosure relates to a display structure, more particularly to a display structure that can enhance color purity and color saturation.

### BACKGROUND

Light-emitting diode (LED) has a small volume, low power consumption, high brightness, etc. In recent years, small electronic products have been expanded into large household appliances and other related fields. At present, the development of large-size, thin and high resolution color display mainly uses the light-emitting diodes as the light-emitting element of the display. The light-emitting element of the display usually has many pixels. Each pixel has red, green and blue light-emitting diode chips. The pixels are arranged to form a full-color light-emitting diode display.

The light-emitting elements of the full-color light-emitting diode display are usually disposed adjacent to each other, and the arrangement in an array is the most common. When the light-emitting elements are arranged in an array, light emitted from adjacent light-emitting diode chips has no specific directivity. In order to have a high resolution display effect, the light-emitting elements are arranged more closely. However, light emitted from adjacent light-emitting elements are likely to interfere with each other, so that the display color is not uniform, thereby affecting the overall color saturation of the display.

### SUMMARY

Therefore, an object of the present disclosure is to provide a display structure that can enhance color saturation, so that the display structure has a uniform overall display color and high color saturation.

According to the present disclosure, a display structure comprises a main body, a plurality of light-emitting diode units, and a plurality of light blocking walls. The main body includes a substrate, and a circuit unit disposed on the substrate. The light-emitting diode units are electrically connected to the circuit unit and illuminate outwardly. Each of the light blocking walls is disposed between two adjacent light-emitting diode units to prevent light interference between the two adjacent light-emitting diode units.

Each of the light blocking walls has a height greater than that of each of the light-emitting diode units.

The light blocking walls are disposed on a surface of the substrate in an intersecting manner.

The light blocking walls extend from the surface of the substrate in a direction away from the substrate and are generally parallel to the light-emitting diode units.

The circuit unit includes a plurality of drive circuits corresponding to the light-emitting diode units respectively, and a plurality of transmission circuits each of which electrically interconnects two adjacent drive circuits. The main body further includes an input circuit electrically connected to one of the drive circuits, and an output circuit electrically connected to another one of the drive circuits.

Each of the drive circuits has a connecting portion, and each of the light-emitting diode units has an electrode portion electrically connected to the connecting portion of the corresponding drive circuits.

Each of the light-emitting diode units includes a red light-emitting diode chip, a green light-emitting diode chip and a blue light-emitting diode chip. The red, green and blue light-emitting diode chips are electrically connected to a corresponding one of the drive circuits.

Each of the light-emitting diode units further includes a light-emitting diode package. The red, green and blue light-emitting diode chips are packaged in the light-emitting diode package.

The efficacy of this disclosure resides in that through the disposition of each light blocking wall between any two adjacent light-emitting diode units, light interference between the any two adjacent light-emitting diode units can be prevented, and the amount of light emitted by the light-emitting diode units in a forward direction can be increased, so that the overall color saturation of the display structure of this disclosure can be enhanced.

### BRIEF DESCRIPTION OF THE DRAWINGS

Other features and advantages of the present disclosure will become apparent in the following detailed description of the embodiments with reference to the accompanying drawings, of which:

FIG. 1 is a fragmentary perspective view of a display structure according to the first embodiment of the present disclosure without an input circuit and an output circuit being omitted;

FIG. 2 is a fragmentary sectional view of the first embodiment;

FIG. 3 is another fragmentary sectional view of the first embodiment, illustrating each light-emitting diode unit including a light-emitting diode package; and

FIG. 4 is a fragmentary sectional view of a display structure according to the second embodiment of this disclosure.

### DETAILED DESCRIPTION

Before this disclosure is described in detail, it should be noted that, in the following description, similar elements are designated by the same reference numerals.

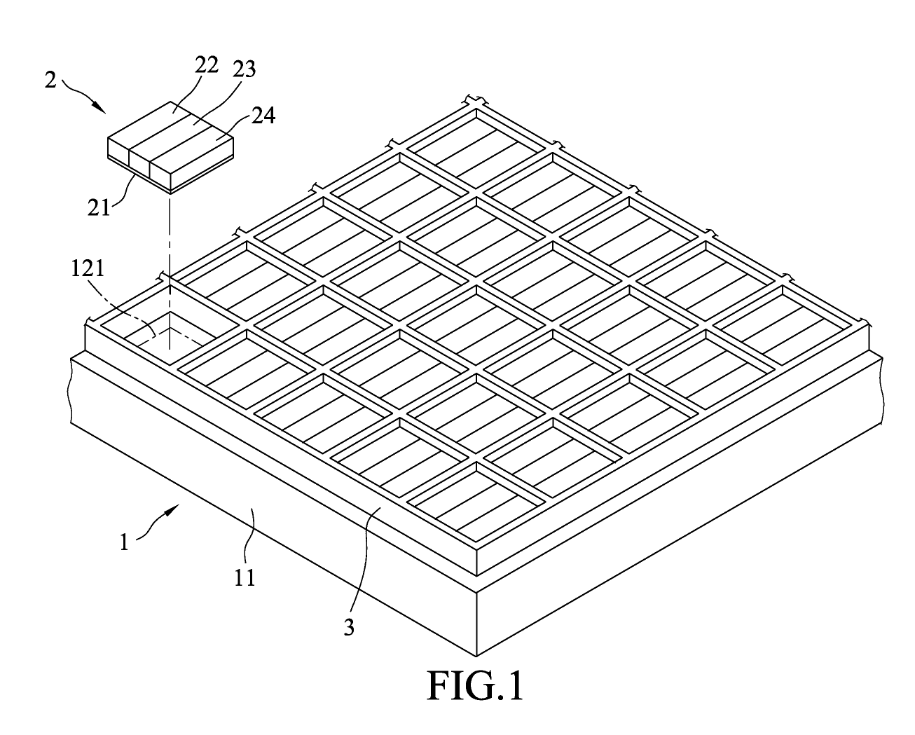

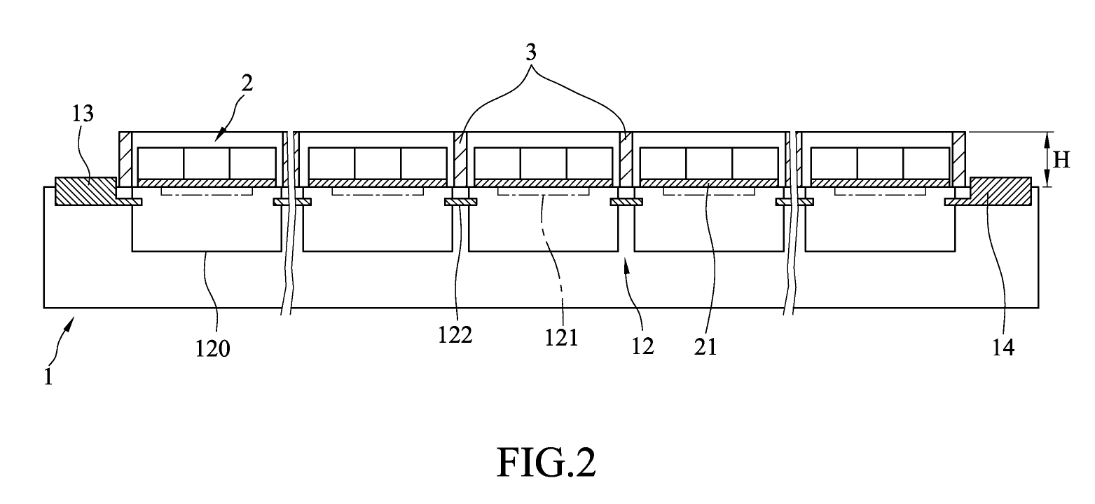

Referring to FIGS. 1 and 2, a display structure according to the first embodiment of the present disclosure is shown to comprise a main body 1, a plurality of light-emitting diode units 2, and a plurality of light blocking walls 3.

The main body 1 includes a substrate 11, a circuit unit 12, an input circuit 13, and an output circuit 14. The substrate 11 can be made of a semiconductor material, such as silicon wafer, but is not limited thereto. The substrate 11 may be made of other semiconductor material depending on the requirement of the circuit unit 12. For example, the semiconductor material may be a germanium wafer or Group III-V semiconductor material.

In this embodiment, the circuit unit 12 includes a plurality of drive circuits 120 corresponding to the light-emitting diode units 2, and a plurality of transmission circuits 122 that each of which electrically interconnects two adjacent drive circuits 120. The input circuit 13 and the output circuit 14 are connected electrically and respectively to two of the drive circuits 120 that are disposed at the substrate 11. Through coordination of the input and output circuits 13 and 14, external electrical power is supplied from the input circuit 13 to the drive circuit 120 which is connected to the input circuit 13, the other drive circuits 120 through the transmission circuits 122, the corresponding light emitting units 2, and finally the output circuit 14 so as to form a complete electrical circuit. That is, the input circuit 13, the transmission circuits 122, the drive circuits 120 and the output circuit 14 can cause the light-emitting diode units 2 to form a light-emitting circuit which can be controlled. In this embodiment, the drive circuits 120 and the transmission circuit 122 can be simultaneously formed on the substrate 11 by using one of the following methods: lithography, etching, thin film deposition and diffusion.

The light-emitting diode units 2 are disposed in an array on the main body 1, and are electrically connected to the circuit unit 12. The light-emitting diode units 2 can convert the electrical energy received from the circuit unit 12 into light energy and emit light. Each of the light-emitting diode units 2 includes a red light-emitting diode chip 22, a green light-emitting diode chip 23 and a blue light-emitting diode chip 24. The red, green and blue light-emitting diode chips 22, 23, 24 are electrically connected to a corresponding one of the drive circuits 120. Since the related processes and selection of constituent materials of the red, green and blue light-emitting diode chips 22, 23, 24 are well known in the art and are not important features of this disclosure, a detailed description thereof is dispensed therewith for the sake of brevity.

Each of the drive circuits 120 has a connecting portion 121. Each of the light-emitting diode units 2 further includes an electrode portion 21. In this embodiment, the connecting portion 121 is disposed on top of a respective one of the drive circuits 120, and is electrically connected to the electrode portion 21 of a respective one of the light-emitting diode units 2. The red, green and blue light-emitting diode chips 22, 23, 24 are electrically connected to the electrode portion 21 and to the connecting portion 121 of the respective drive circuit 120 via the electrode portion 21. When electricity is supplied by each drive circuit 120 to the electrode portion 21 of the respective light-emitting diode unit 2, the red, green and blue light-emitting diode chips 22, 23, 24 will convert the electrical energy to light energy and respectively emit red, green and blue lights. Light emitted from each light-emitting diode unit 2 is a mixture of the red, green and blue lights.

It is worth mentioning that each of the red, green and blue light-emitting diode chips 22, 23, 24 may be replaced by a light-emitting diode chip which can emit a short wavelength light, such as blue or ultraviolet light, and a wavelength conversion layer (not shown) is formed thereon. The wavelength conversion layer absorbs light emitted from the light-emitting diode chip and an excitation light (for example, red, yellow or green light) having a wavelength greater than the short wavelength light (blue or ultraviolet light) is generated. Thus, the wavelength conversion layer can be used to further adjust the color rendering index (CRI) and the color temperature of the light-emitting diode unit 2.

Each of the light blocking walls 3 is disposed between the two adjacent light-emitting diode units 2 to prevent interference between the light emitted from the two adjacent light-emitting diode units 2. Hence, the material of the light blocking wall 3 is opaque, so that light emitted from the light-emitting diode units 2 can be blocked by the light blocking walls 3, thereby resolving the problem of light interference between the two adjacent light-emitting diode units 2. The light blocking walls 3 may be formed on the substrate 11 by using lithography, thin film deposition, etc. In this embodiment, each light blocking wall 3 is made of an opaque photoresist material. In coordination with the arrayed light-emitting diode units 2, the light blocking walls 3 are disposed on a surface of the substrate 11 in an intersecting manner using a lithography process. Specifically, the light blocking walls 3 extend perpendicularly from the surface of the substrate 11 in a direction away from the substrate 11. In order to effectively block light interference between two adjacent light-emitting diode units 2, the height (H) of each light blocking wall 3 is greater than that of each light-emitting diode unit 2.

Further, as long as each light blocking wall 3 is formed between two adjacent light-emitting diode units 2 so as to separate the same and can prevent light interference between the light-emitting diode units 2, the arrangement of the light-emitting diode units 2 is not limited to the aforesaid disclosure. Depending on the display requirement, the light-emitting diode units 2 may be arranged to form a polygonal or a specific shape. In this case, the disposition of each light blocking wall 3 is adjusted according to the altered arrangement of the light-emitting diode units 2.

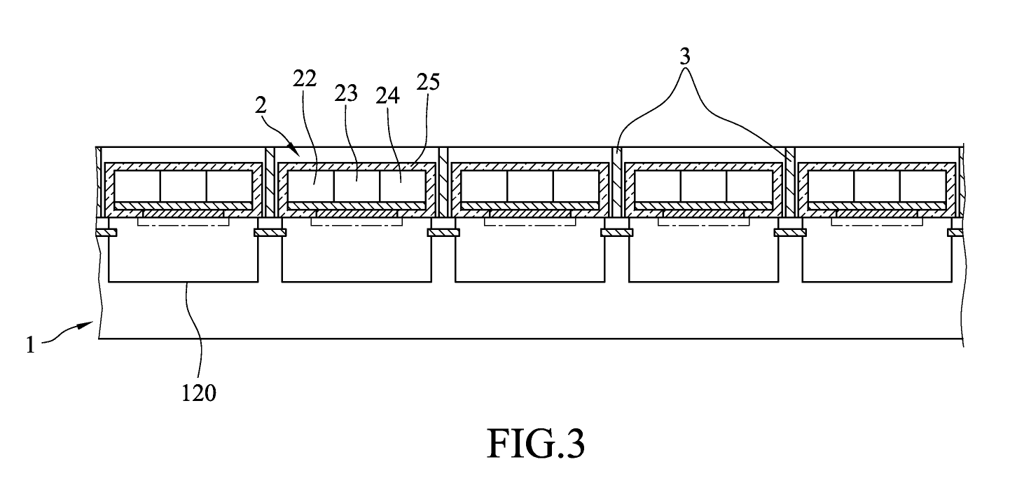

With reference to FIG. 3, each light-emitting diode unit 2 further includes a light-emitting diode package 25. The red, green and blue light-emitting diode chips 22, 23, 24 are packaged in the light-emitting diode package 25. The packaging method may be changed according to the requirement. For example, the red, green and blue light-emitting diode chips 22, 23, 24 may first be disposed on the main body 1, after which the light-emitting diode package 25 is used to package the light-emitting diode chips 22, 23, 24. Or, the light-emitting diode chips 22, 23, 24 may first be packaged individually, after which the packaged light-emitting diode chips 22, 23, 24 are disposed on the main body 1.

It is worth mentioning that because the light-emitting diode package 25 is transparent, it will not affect the luminescence brightness of the light-emitting diode chips 22, 23, 24. Further, with each light blocking wall 3 disposed between two adjacent ones of the light-emitting diode packages 25, the light-emitting diode chips 22, 23, 24 are not only protected from external factors which may affect the luminous quality thereof, but also the color saturation and the color purity thereof can be enhanced.

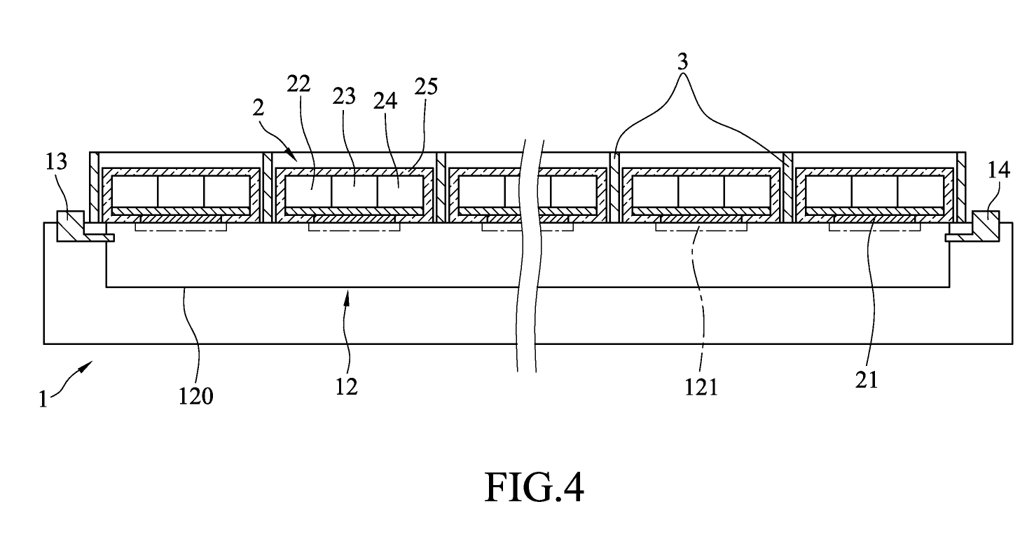

Referring to FIG. 4, a display structure according to the second embodiment of the present disclosure is shown to be similar to the first embodiment. However, in this embodiment, the circuit unit 12 includes only one drive circuit 120 which is electrically connected to the input circuit 13, the output circuit 14, and the light-emitting diode units 2. The drive circuit 120 has a plurality of the connecting portions 121 connected electrically and respectively to the electrode portions 21 of the light-emitting diode units 2. The drive circuit 120 can simultaneously output a same control signal or different sets of control signals to the light-emitting diode units 2, and can control the light-emitting diode units 2 to operate simultaneously or separately. When an external electrical power is supplied from the input circuit 13 to the drive circuit 120 and the output circuit 14, a light-emitting circuit that can be controlled is formed. That is, the electrical power is simultaneously fed to the electrode portions 21 of the light-emitting diode units 2 through the connecting portions 121 of the drive circuit 120 so as to control the ON-OFF operation of the light-emitting diode units 2.

In sum, the display structure of this disclosure uses the opaque light blocking walls 3, each of which is disposed between two adjacent ones of the light-emitting diode units 2 or the light-emitting diode packages 25, and each of which has the height (H) greater than that of each light-emitting diode unit 2 or each light-emitting diode package 25, light interference between two adjacent ones of the light-emitting diode units 2 can be prevented, and the amount of light emitted by the light-emitting diode units 2 in a forward direction can be increased. The overall color saturation of the display structure of this disclosure can thus be enhanced. Hence, the object of this disclosure is realized.

While the present disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A display structure, comprising:
a main body including a substrate, and a circuit unit disposed on said substrate;
a plurality of light-emitting diode units electrically connected to said circuit unit and illuminating outwardly; and
a plurality of light blocking walls, each of which is disposed between two adjacent ones of said light-emitting diode units to prevent light interference between the two adjacent ones of said light-emitting diode units.

2. The display structure as claimed in claim 1, wherein each of said light blocking walls has a height greater than that of each of said light-emitting diode units.

3. The display structure as claimed in claim 1, wherein said light blocking walls are disposed on a surface of said substrate in an intersecting manner.

4. The display structure as claimed in claim 1, wherein said light blocking walls extend from said surface of said substrate in a direction away from said substrate and are generally parallel to said light-emitting diode units.

5. The display structure as claimed in claim 1, wherein said circuit unit includes a plurality of drive circuits corresponding to said light-emitting diode units, and a plurality of transmission circuits each of which electrically interconnects two adjacent ones of said drive circuits, said main body further including an input circuit electrically connected to one of said drive circuits, and an output circuit electrically connected to another one of said drive circuits.

6. The display structure as claimed in claim 5, wherein each of said drive circuits has a connecting portion, and each of said light-emitting diode units has an electrode portion electrically connected to said connecting portion of a corresponding one of said drive circuits.

7. The display structure as claimed in claim 5, wherein each of said light-emitting diode units includes a red light-emitting diode chip, a green light-emitting diode chip and a blue light-emitting diode chip, said red, green and blue light-emitting diode chips being electrically connected to a corresponding one of said drive circuits.

8. The display structure as claimed in claim 7, wherein each of said light-emitting diode units further includes a light-emitting diode package, said red, green and blue light-emitting diode chips being packaged in said light-emitting diode package.

9. The display structure as claimed in claim 1, wherein said main body further includes an input circuit and an output circuit, and said circuit unit includes a drive circuit electrically connected to said input circuit, said output circuit and said light-emitting diode units.

10. The display structure as claimed in claim 9, wherein said drive circuit has a plurality of connecting portions, and each of said light-emitting diode units has an electrode portion electrically connected to a respective one of said connecting portions of said drive circuit.

11. The display structure as claimed in claim 9, wherein each of said light-emitting diode units includes a red light-emitting diode chip, a green light-emitting diode chip and a blue light-emitting diode chip, said red, green and blue light-emitting diode chips being electrically connected to said drive circuit.

12. The display structure as claimed in claim 11, wherein each of said light-emitting diode units further includes a light-emitting diode package, said red, green and blue light-emitting diode chips being packaged in said light-emitting diode package.
